(19) United States
(12) Patent Application Publication
(10) Pub. No.: US 2010/0327757 A1
(43) Pub. Date: Dec. 30, 2010

(54) INTELLIGENT LED LAMP

(75) Inventors: SHIN-HONG CHUNG, Tu-Cheng (TW); TSUNG-HUAN HSIEH, Tu-Cheng (TW); WEN-HSIANG LU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/566,682

(22) Filed: Sep. 25, 2009

(30) Foreign Application Priority Data
Jun. 30, 2009 (CN) 200910303884.7

(51) Int. Cl. H05B 39/04

(52) U.S. Cl. 315/158

(57) ABSTRACT

An intelligent light emitting diode (LED) lamp includes a power management unit connected to a power source configured for supplying power; a LED lighting unit; a motion sensor configured for detecting whether there is someone around the LED lamp and producing a trigger signal when detecting that someone is around; a light detector configured for detecting current ambient light level and generating a light signal according to the current ambient light level; and a processing unit configured for controlling the LED lighting unit to light, generating and passing on a communication signal to other LED lamps, upon condition that the trigger signal is received and the current ambient light level is determined less than a predetermined value according to the light signal.

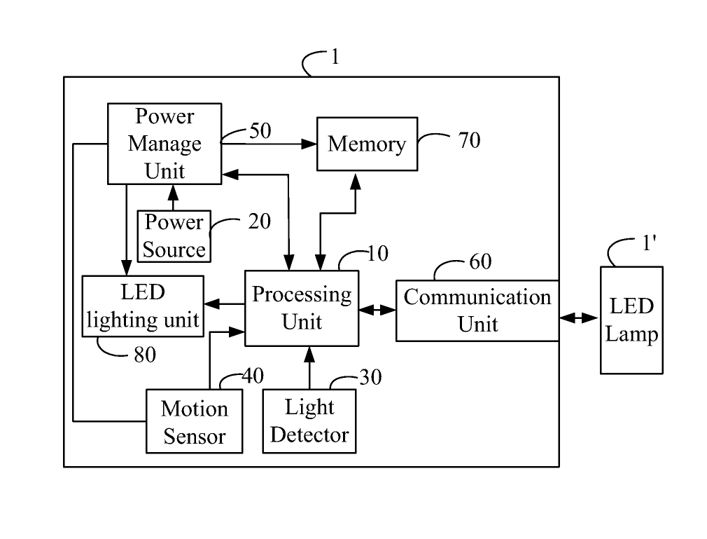

### BACKGROUND

1. Technical Field

The disclosure relates to light emitting diode (LED) lamps and, particularly, to an intelligent LED lamp that can control its brightness automatically and communicate with other LED lamps.

2. Description of Related Art

Usually, lamps in streets, corridors, or staircases can be set to light up when someone walks within a predetermined area of proximity to the lamps in darkness. However, such lamps are unable to control other lamps when one lamp is lighted up.

Therefore, it is useful to provide an intelligent LED lamp to overcome the above-mentioned shortcoming.

### BRIEF DESCRIPTION OF THE DRAWINGS

The components in the drawing are not necessarily drawn to scale, the emphasis instead being placed upon clearly illustrating the principles of the intelligent LED lamp.

The drawing is a block diagram of a lighting system including intelligent LED lamps in accordance with an exemplary embodiment.

### DETAILED DESCRIPTION

Referring to the drawing, a lighting system includes at least two intelligent LED lamps (LED lamp 1 and LED lamp 1′ shown in the drawing). The LED lamps in the lighting system have the same internal structure. In order to make it clear and easy to understand, only two LED lamps are illustrated as an example, and LED lamp 1 is selected to illustrate the internal structure in the disclosure. Each of the LED lamps 1, 1′ can be lit by receiving a communication control signal from other LED lamps. Each LED lamp can also light up automatically upon sensing someone within a predetermined area of proximity or the ambient light level being relatively dark without the communication control signal, and adjust its brightness, then pass on the communication control signal to other LED lamps in the lighting system.

The LED lamp 1 includes a processing unit 10, a power source 20, a light detector 30, a motion sensor 40, a power manage unit 50, a communication unit 60, a memory 70, and a LED lighting unit 80.

The communication unit 60 is configured to connect and communicate with other LED lamps. The type of the communication unit 60 may be wireless or wired. The LED lighting unit 80 is configured for emitting light.

The storage unit 70 is configured to store a table. The table includes a plurality of light level ranges and a plurality of preferred brightness values corresponding to the light level ranges relatively. The light level ranges represent various ranges of ambient light levels, for example, quite dark, dark, normal, light, quite light and so on. For each light level range, there is one preferred brightness value accordingly.

The power source 20 is connected to the power management unit 50. The power source 20 may be a battery or an alternating current to direct current module. The power management unit 50 is configured to supply power from the power source 20 to elements of the LED lamp 1, such as the processing unit 10, the motion sensor 40, the light detector 30, the communication unit 60, and the LED lighting unit 80. In the exemplary embodiment, when the LED lamp 1 is activated, the power management unit 50 is configured to continuously supply power to the processing unit 10 and the motion sensor 40. Other elements can be supplied power according to the control of the processing unit 10.

The light detector 30 is configured to detect a current ambient light level and produce a light signal to the processing unit 10.

The motion sensor 40, connected to the processing unit 10, is configured for detecting whether there is someone within a predetermined area of proximity to the LED lamp 1, and producing a trigger signal to the processing unit 10 when there is. The motion sensor 40 may include any one or more of the following, an infrared detector, a sonar detector, an audio detector, or the like, which can work singly or in combination according to preset parameters to generate the trigger signal when it is likely one or more persons are present in the predetermined area.

The processing unit 10 is configured to control the power management unit 50 to power on the light detector 30 when receiving the trigger signal. The processing unit 10 is also configured to convert the light signal to digital light level value, look up the digital light level value in the table in the storage unit 70 to determine the light level range that the digital light level value is included in. The processing unit 10 is also configured to obtain the preferred brightness value according to the determined light level range, control the LED light unit 80 to light up and adjust the brightness according to the preferred brightness value, generate and pass on the communication control signal to other LED lamps via the communication unit 60.

In the embodiment, the motion sensor 40 continuously detects whether there is someone around the LED lamp 1. The motion sensor 40 is also configured to produce a stop signal when it detects that nobody is within the predetermined area and when a predetermined time period has elapsed after the LED lamp 1 was lit. The processing unit 10 controls the power management unit 50 to stop supplying power to the LED lighting unit 80 and other elements of the LED lamp 1 whose functions are not currently needed when receiving the stop signal. Thereby, if there is nobody around, the LED lighting unit 80 will be powered off automatically to avoid wasting power. The predetermined time period may be pre-stored in the storage unit 70.

The processing unit 10 controls the power manage unit 50 to supply power to the light detector 30. The light detector 30 sends the light signal to the processing unit 10 after being powered on. The processing unit 10 converts the light signal to digital light level value, looks up the digital light level value in the table in the storage unit 70 to determine the light level range that the digital light level value is included in. The processing unit 10 also obtains the preferred brightness value according to the determined light level range, and adjusts the brightness of the LED lighting unit 80 according to the preferred brightness value.

In other embodiments, the processing unit 10 can control the LED lighting unit 80 to light when the motion sensor 40 detects there is someone around and the current ambient light level is lower than a predetermined value, and need not adjust the brightness of the LED lighting unit 80. The predetermined value may be pre-stored in the memory 70. The processing unit 10 can also control the LED lighting unit 80 to light when receiving the communication signal from other LED lamps.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. An intelligent light emitting diode (LED) lamp comprising:
a power management unit connected to a power source, configured for supplying power from the power source;
a LED lighting unit configured for emitting light;
a motion sensor configured for detecting whether there is someone around the LED lamp and producing a trigger signal when detecting that someone is around;
a light detector configured for detecting current ambient light level and generating a light signal according to the current ambient light level; and
a processing unit configured for controlling the LED lighting unit to light, generating and passing on a communication signal to other LED lamps, upon condition that the trigger signal is received and the current ambient light level is determined less than a predetermined value according to the light signal.

2. The intelligent LED lamp of claim 1, wherein the predetermined value is pre-stored in a memory.

3. The intelligent LED lamp of claim 1, further comprising a storage unit configured for storing a plurality of light level ranges and a plurality of preferred brightness values corresponding to the light level ranges, wherein the processing unit is further configured to convert the light signal to a digital light level value, compare the digital light level value with the light level ranges to determine one light level range that the digital light level value is included in, obtain the preferred brightness value according to the determined light level range, and adjust the brightness of the LED lighting unit according to the preferred brightness value.

4. The intelligent LED lamp of claim 1, wherein the processing unit is further configured for controlling the LED lighting unit to light when receiving the communication signal from other LED lamps.

5. The intelligent LED lamp of claim 1, wherein the motion sensor comprises one selected from the group consisting of an infrared detector, a sonar detector, and an audio detector.

6. The intelligent LED lamp of claim 1, wherein the motion sensor comprises two or more of the infrared detector, the sonar detector, or the audio detector.

7. The intelligent LED lamp of claim 1, wherein the motion sensor is further configured to produce a stop signal when it detects that nobody is within the predetermined area and when a predetermined time period has elapsed after the LED lighting unit is powered on, and the processing unit is further configured to control the power management unit to stop supplying the power to the LED lighting unit and other elements of the LED lamp whose functions are not currently needed when receiving the stop signal.

8. A method of automatically adjusting brightness of an intelligent light emitting diode (LED) lamp, the method comprising:
detecting whether there is someone around the LED lamp and producing a trigger signal when having detected that someone is around;
detecting current ambient light level and producing a light signal corresponding to the detected ambient light level; and
controlling a LED lighting unit of the LED lamp to light, generating and sending a communication signal to other LED lamps, upon condition that the trigger signal is received and the current ambient light level is determined less than a predetermined value according to the light signal.

9. The method of claim 8, wherein the step of detecting current ambient light level and producing a light signal further comprises:
controlling a light detector of the LED lamp to work when receiving the trigger signal.

10. The method of claim 8, further comprising:
supplying a storage unit for storing a plurality of light level ranges and a plurality of preferred brightness values corresponding to the light level ranges;
converting the light signal to a digital light level value;
comparing the digital light level value with the light level ranges to determine one light level range that the digital light level value is included in;
obtaining the preferred brightness value according to the determined light level range; and
adjusting the brightness of the LED light unit according to the preferred brightness value.

11. The method of claim 8, further comprising: controlling the LED lighting unit to light when receives the communication signal from other LED lamps.

12. The method of claim 8, further comprising:
producing a stop signal when detecting that nobody is within the predetermined area and when a predetermined time period has elapsed after the LED lighting unit was lit; and
controlling the power management unit to discontinue the power to the LED lighting unit and other elements of the LED lamp whose functions are not currently needed when receiving the stop signal.
